(19) United States
(12) Patent Application Publication
(10) Pub. No.: US 2024/0312359 A1
(43) Pub. Date: Sep. 19, 2024

(54) ANALYSIS APPARATUS, ANALYSIS METHOD, AND NON-TRANSITORY COMPUTER-READABLE MEDIUM

(71) Applicant: NEC Corporation, Tokyo (JP)

(72) Inventors: Shin NORIEDA, Tokyo (JP); Hiroo HARADA, Tokyo (JP); Hanuki MIZUTANI, Tokyo (JP); Hirotaka MAESHIMA, Tokyo (JP); Masami SAKAGUCHI, Tokyo (JP)

(73) Assignee: NEC Corporation, Minato-ku, Tokyo (JP)

(21) Appl. No.: 18/276,624

(22) PCT Filed: Jan. 14, 2022
(86) PCT No.: PCT/JP2022/001190

§ 371 Date: Aug. 9, 2023

(30) Foreign Application Priority Data
Feb. 25, 2021 (JP) 2021-029037

(51) Int. Cl. G09B 7/00; G06V 40/16; G06V 40/20

(52) U.S. Cl. CPC G09B 7/00; G06V 40/174; G06V 40/20

(57) ABSTRACT

An analysis apparatus or the like capable of supplying content appropriate for a learner is supplied. An analysis apparatus includes: a content provision unit that supplies a learner with content including an examination question; an acquisition unit that acquires emotion data regarding learning of the learner for which an emotion analysis has been performed on face image data of the learner who learns using the content; a reception unit that receives a response of the learner to the examination question; and a content control unit that controls subsequent content based on the acquired emotion data and a result of the response.

### TECHNICAL FIELD

The present invention relates to an analysis apparatus, an analysis method, and an analysis program.

### BACKGROUND ART

With advances in information communication technologies, use of online learning and online examinations is expanding. Techniques for analyzing situations of learners during online learning have been proposed.

For example, Patent Literature 1 discloses an emotion estimation system that enables a computer to estimate a change in emotion from dynamic face image data of a person with high accuracy, and grasps an emotion of a learner using a learning support system represented by e-learning to supply learning materials matching the emotion with higher accuracy, and a learning system using the emotion estimation system.

Furthermore, Patent Literature 2 discloses an information processing apparatus that supports learning of a learner. The information processing apparatus generates new questions according to the degree of understanding of learners or acquires the new questions from a question database and presents the new questions to learner terminals.

### CITATION LIST

### Patent Literature

Patent Document 1: Japanese Patent Application Laid-Open No. 2011

Patent Literature 2: International Patent Publication No. 2019/176373

### SUMMARY OF INVENTION

### Technical Problem

In the learning system according to the above-described Patent Literature 1, a learning material appropriate for a learner still cannot be accurately supplied. The information processing apparatus according to the above-described Patent Literature 2 still cannot supply a learning material sufficiently appropriate for a learner.

The present disclosure has been made in view of such problems, and an object of the present disclosure is to provide an analysis apparatus, an analysis method, and an analysis program capable of supplying content appropriate for a learner.

### Solution to Problem

According to a first aspect of the present disclosure, an analysis apparatus includes: a content provision unit configured to supply a learner with content including an examination question: an acquisition unit configured to acquire emotion data regarding learning of the learner for which an emotion analysis has been performed on face image data of the learner who learns using the content: a reception unit configured to receive a response of the learner to the examination question; and a content control unit configured to control subsequent content based on the acquired emotion data and a result of the response.

According to a second aspect of the present disclosure, an analysis method includes: supplying a learner with content including an examination question; acquiring emotion data regarding learning of the learner for which an emotion analysis has been performed on face image data of the learner who learns using the content: receiving a response of the learner to the examination question; and controlling subsequent content based on the acquired emotion data and a result of the response.

According to a third aspect of the present disclosure, an analysis program causes a computer to perform: supplying a learner with content including an examination question: acquiring emotion data regarding learning of the learner for which an emotion analysis has been performed on face image data of the learner who learns using the content: receiving a response of the learner to the examination question; and controlling subsequent content based on the acquired emotion data and a result of the response.

### Advantageous Effects of Invention

According to the present disclosure, it is possible to provide an analysis apparatus, an analysis method, and an analysis program capable of supplying content appropriate for a learner.

### BRIEF DESCRIPTION OF DRAWINGS

FIG. 1 is a block diagram illustrating a configuration of an analysis apparatus according to a first example embodiment.

FIG. 2 is a flowchart illustrating an analysis method according to the first example embodiment.

FIG. 3 is a block diagram illustrating a configuration of an analysis apparatus according to a second example embodiment.

FIG. 4 is a flowchart illustrating an analysis method according to a second example embodiment.

FIG. 5 is a block diagram illustrating a configuration of an analysis system according to a third example embodiment.

FIG. 6 is a block diagram illustrating a configuration of an analysis apparatus according to the third example embodiment.

FIG. 7 is a diagram illustrating an example of data processed by an analysis data generation unit.

FIG. 8 illustrates an example of a distribution for specific emotion data calculated from emotion data of a plurality of learners.

FIG. 9 is a block diagram illustrating a configuration of an emotion data generation apparatus according to the third example embodiment.

FIG. 10 is a flowchart illustrating an analysis method according to the third example embodiment.

FIG. 11 is a diagram illustrating an example of analysis data.

FIG. 12 is a diagram illustrating an example of content data.

### EXAMPLE EMBODIMENT

Hereinafter, example embodiments of the present disclosure will be described in detail with reference to the drawings. In the drawings, the same or corresponding elements are denoted by the same reference numerals, and repeated description is omitted as necessary for clear description.

### First Example Embodiment

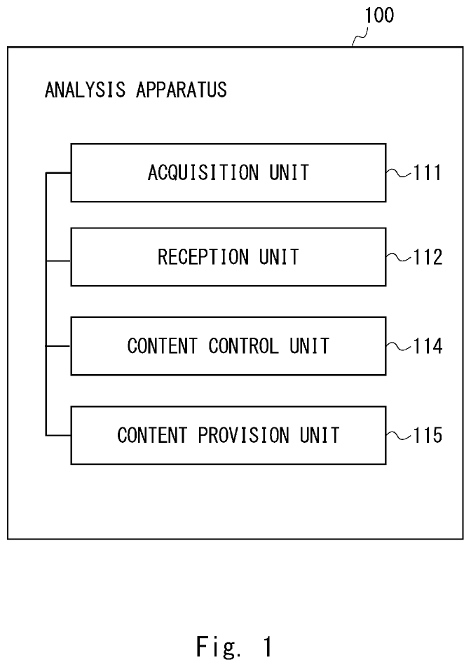

FIG. 1 is a block diagram illustrating a configuration of an analysis apparatus 100 according to a first example embodiment.

The analysis apparatus 100 is implemented by an information processing apparatus such as a computer that includes a processor and a memory. The analysis apparatus 100 is used to analyze an emotion of a learner in learning such as online learning or an online examination.

The analysis apparatus 100 includes: a content provision unit 115 that supplies a learner with content including an examination question: an acquisition unit 111 that acquires emotion data regarding learning of the learner for which an emotion analysis has been performed on face image data of the learner who learns using the content: a reception unit 112 that receives a response of the learner to the examination question; and a content control unit 114 that controls subsequent content based on the acquired emotion data and the response result.

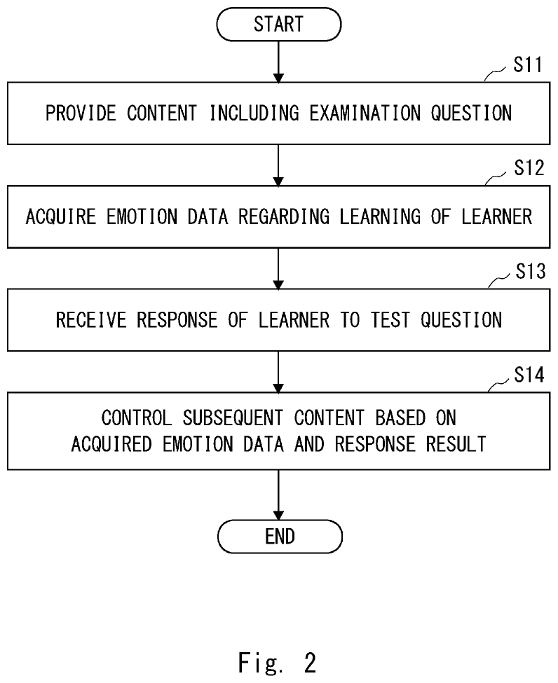

FIG. 2 is a flowchart illustrating an analysis method according to the first example embodiment. The flowchart illustrated in FIG. 2 starts, for example, when the analysis apparatus 100 receives a signal indicating start of learning from a learning management apparatus.

The content provision unit 115 supplies the learner with content including an examination question (step S11). The acquisition unit 111 acquires emotion data regarding learning of the learner for which the emotion analysis has been performed on the face image data of the learner who learns using the content (step S12). The reception unit 112 receives a response of the learner to the examination question (step S13). The content control unit 114 controls subsequent content based on the acquired emotion data and the response result (step S14).

According to the example embodiment described above, it is possible to provide an analysis apparatus and an analysis method capable of supplying content appropriate for a learner based on an emotion analysis and a response result of the learner.

### Second Example Embodiment

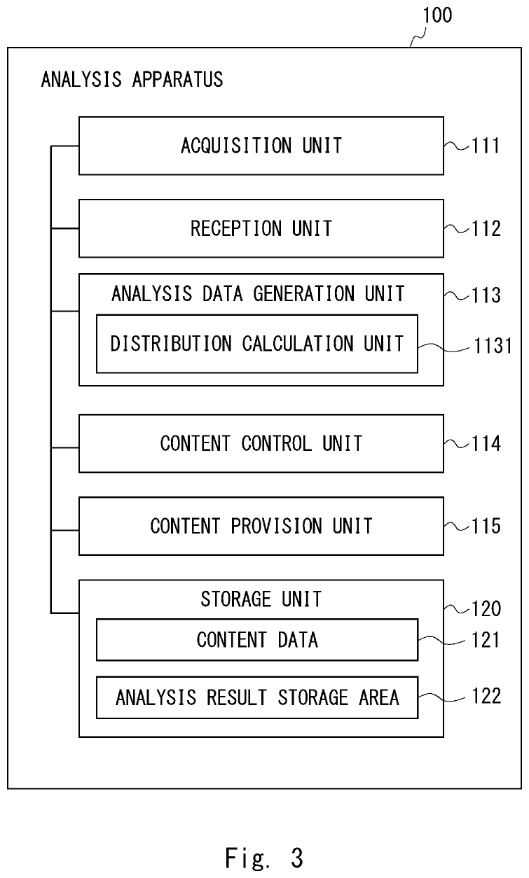

FIG. 3 is a block diagram illustrating a configuration of an analysis apparatus 100 according to a second example embodiment. The analysis apparatus 100 acquires emotion data from face image information of a learner or an examinee of online learning or an online examination, generates analysis data regarding the online learning or the online examination from the acquired emotion data, and changes learning content based on the generated analysis data.

In the example embodiment, the online learning is learning performed using one or a plurality of learning terminals communicably connected to each other via a communication line. The online learning may have a format in which a class video is delivered in real time or a format in which a class video is delivered on demand. The number of learning terminals is not limited, but may be, for example, the number of students belonging to one class of a school (for example, 20, 30 or any appropriate number), the number of students corresponding to the first grade of a school (for example, 100 or any appropriate number), the number of examinees of a qualification test (for example, 3000 or any appropriate number), or the like. The online learning used in the present specification includes not only an online class (also referred to as remote joint class) conducted at school, a cram school, or the like, but also an online examination (also referred to as remote joint examination) such as an entrance examination, an employment examination, a selection examination, or a term examination of a school or the like. The learning terminal used for the online learning is any appropriate terminal such as a personal computer, a smartphone, a tablet terminal, or a mobile phone with a camera. The learning terminal is not limited to the above as long as the learning terminal is an apparatus that has a camera that captures an image of a learner, a microphone that collects speeches of a learner, and a communication function of transmitting and receiving image data and audio data. In the following description, the online learning is simply referred to as “learning” in some cases.

In the example embodiment, a learner of online learning is a person who is performing online learning with a learning terminal. Examples of a manager of the learning includes a learning organizer, a learning teacher, and an examination supervisor. In the example embodiment, it is assumed that the learner participates in learning in a state in which a face image of the learner can be captured by a camera built in or connected to the learning terminal.

The analysis apparatus 100 is communicably connected to an emotion data generation apparatus that generates emotion data from a face image or the like of a learner in online learning and a learning operation apparatus that operates the learning. The analysis apparatus 100 may be built in a learning operation apparatus. A terminal (a manager terminal) carried by a manager using the analysis apparatus 100 is communicably connected to the analysis apparatus 100. As illustrated in FIG. 3, the analysis apparatus 100 mainly includes an emotion data acquisition unit 111, a reception unit 112, an analysis data generation unit 113, a content control unit 114, a content provision unit 115, and a storage unit 120.

The acquisition unit 111 acquires the emotion data from the emotion data generation apparatus. The emotion data generation apparatus generates emotion data from face image data of participants in learning in online learning, and supplies the generated emotion data to the analysis apparatus 100. The emotion data is data serving as an index indicating each emotion of the participants in learning.

The emotion data includes, for example, a plurality of items such as a degree of concentration, a degree of confusion, a degree of happiness, anxiety, and surprise. That is, the emotion data indicates how much a learner feels these emotions for each of the above-described items. The emotion data acquired by the acquisition unit 111 includes time data. The emotion data generation apparatus generates emotion data for each predetermined period of time (for example, one second). The acquisition unit 111 acquires emotion data for each predetermined time throughout a learning progress time. When the emotion data is acquired, the acquisition unit 111 supplies the acquired emotion data to the analysis data generation unit 113.

The reception unit 112 receives a response of the learner to the examination questions supplied from the learning operation apparatus via the learning terminal. The learning management apparatus is, for example, a server apparatus to which each learner is communicably connected through a learning terminal. In several example embodiments, the learning operation apparatus may be included in a learning terminal used by a learner. The learning content data is data regarding the learning involving time data. More specifically, the learning content data includes a start time and an end time of the learning. The learning content data includes a time of a break taken during the class.

The reception unit 112 acquires learning content data including learning attribute data. The attribute data of the learning can include, for example, information indicating a type of learning such as an online class or an online examination (more specifically, for example, a selection examination, a term examination, and the like). The attribute data of the learner may include information regarding a school that the learning participant attends. The attribute data of the learning may include information regarding a subject of the learning and a purpose of the learning. The reception unit 112 supplies the acquired response data to the analysis data generation unit 113 and the content control unit 114.

The analysis data generation unit 113 generates analysis data for learning from the received emotion data, response data, and data indicating a chapter. The analysis data is data derived from the emotion data and the response data and is data extracted or calculated from items indicating a plurality of emotions. The analysis data is preferably an index useful for management of the learning. For example, the analysis data may include the degree of concentration on the learning and the degree of understanding. In this way, the analysis data generation unit 113 generates analysis data corresponding to a plurality of preset analysis items. Accordingly, the analysis apparatus 100 can generate analysis data from a plurality of viewpoints at which the learning is efficiently performed. The analysis data generation unit 113 can generate analysis data for a plurality of learners.

The analysis data generation unit 113 can generate analysis data (for example, transition of the degree of concentration, anxiety, and the degree of understanding for learning content data) of a specific learner by comparing the learning content data with the emotion data of the specific learner. For example, it is possible to analyze that the degree of concentration of certain learners is reduced for a specific scene in class. However, it is not possible to distinguish whether the problem is an individual problem of the learner or a problem of the learning content only from the analysis data of one learner. Accordingly, the analysis data generation unit according to the example embodiment can aggregate emotion data of a plurality of learners and statistically process a large amount of data.

The analysis data generation unit 113 further includes a distribution calculation unit 1131. The distribution calculation unit 1131 calculates a distribution of specific analysis data from specific analysis data (for example, the degree of concentration) of each learner (that is, from the aggregated data,). For example, in a scene of a class, a value exceeding a predetermined threshold (for example, standard deviations o, 20, 30, or the like) from an average value is identified from a distribution of specific emotion data (for example, the degree of concentration). Accordingly, it is possible to distinguish whether the problem is an individual problem of the learner or a problem of the learning content data (for example, teacher's teaching method). For example, in a specific scene in a class, when the degree of concentration of almost all the learners is low, it is determined in some cases that almost all the learners are taking notes. Conversely, when almost all the learners have a low degree of concentration and a part of the learners have a significantly high degree of concentration, it may be determined that they are performing an abnormal action (for example, the user is doing something different from the class). When the degree of concentration of only some of the learners is significantly low, it is determined that some of the learners cannot keep up with the class in some cases.

Even in the case of an online examination, it is possible to statistically process the emotion data of each examinee when each examinee solves the same problem, and to identify the examinee who takes an abnormal behavior. For example, when the degree of concentration of a certain examinee is significantly low, it may be determined that the certain examinee performs cheating.

The analysis data generation unit 113 can also statistically process response data for specific examination questions of a plurality of learners received from the reception unit 112. For example, when an accuracy rate of all the learners of one class is less than a threshold (for example, 30%) for a certain examination question, it can be determined that the question is a difficult question. On the other hand, when the accuracy rate of all the learners of one class is equal to or higher than a threshold (for example, 70%) for a certain examination question, it can be determined that the question is an easy problem.

The analysis data generation unit 113 may set a method of calculating the analysis data in accordance with the attribute data received from the reception unit 112. That is, in this case, the analysis data generation unit 113 selects a method of calculating the analysis data in accordance with the attribute data (for example, an online class, an online examination, or a subject) received from the reception unit 112. Accordingly, the analysis apparatus 100 can calculate analysis data in accordance with learning attributes. When the analysis data is generated, the analysis data generation unit 113 supplies the generated analysis data to the content control unit 114.

The content control unit 114 receives the analysis data from the analysis data generation unit 113 and reads the content data 121 from the storage unit 120. The content control unit 114 receives the learning content data from the reception unit 112. Then, the content control unit 114 selects corresponding content from the received analysis data and response data. The content control unit 114 causes the storage unit 120 to store the selected content so that the selected content can be output.

For example, when the degree of concentration of one or more students is significantly low and considerably deviates from the average value from the analysis data (for example, distribution data of the degree of concentration), content for improving the degree of concentration can be extracted and reproduced by, for example, a learning terminal used by the student. Accordingly, the students concentrate more on the classes.

Alternatively, in still another example, for example, an alert indicating “there is a possibility of the student not being able to keep up with the class” may be extracted from the analysis data (for example, analysis data of the degree of anxiety) to students feeling anxiety more than other students.

Alternatively, in another example, for example, during the online examination, when it is determined from the emotion data and the response data that the degree of understanding of one or more students is significantly lower than that of other students and considerably deviates from the average value, a question with a low difficulty level can be extracted and presented to the learning terminal used by the student. In this case, content to be described more simply or content to be described more slowly may be reproduced by the learning terminal used by the student.

The content provision unit 115 supplies the content stored in the storage unit 120 to the learning terminal based on the control signal from the content control unit 114. The manager (for example, an organizer, a teacher, an examination supervisor, and the like of the learning) who uses the analysis apparatus 100 can recognize which kind of emotion the learner has toward learning content, content of examination questions, a statement of the teacher or another student, or the like by perceiving the analysis result received by the manager terminal. The manager using the analysis apparatus 100 can recognize which action the manager should take for the next learning by perceiving an alert or an advice included in the analysis result. Therefore, the manager can perceive, from the received analysis data, attentions or the like for learning to be held later.

The storage unit 120 is a storage device including a non-volatile memory such as a solid state drive (SSD) or a flash memory. The storage unit 120 includes the content data 121 and an analysis result storage area 122. The content data 121 is data in which patterns of the emotion data of the learner and the response data to the examination question are associated with the learning content data. The analysis result storage area 122 is an area where the analysis result generated by the analysis data generation unit 113 is stored.

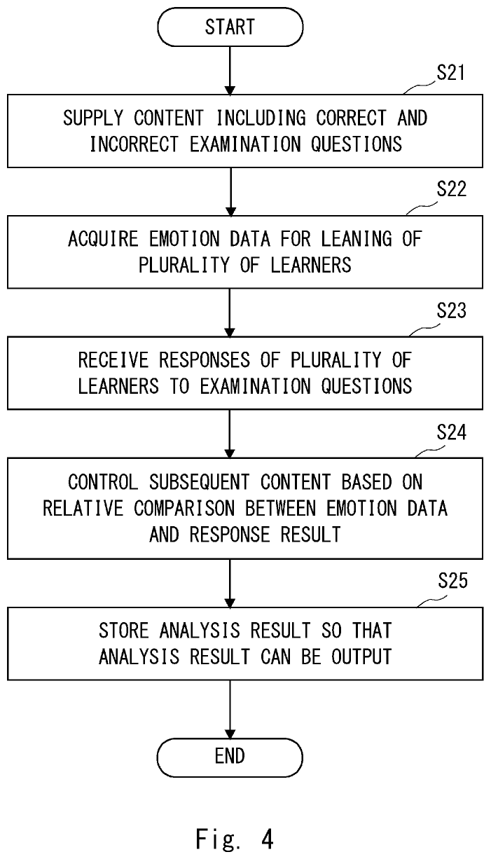

Next, a process of the analysis apparatus 100 according to the first example embodiment will be described with reference to FIG. 4. FIG. 4 is a flowchart illustrating an analysis method according to the second example embodiment. The flowchart illustrated in FIG. 4 starts, for example, when analysis apparatus 100 receives a signal indicating start of the learning from the learning management apparatus.

First, the content provision unit 115 supplies content including examination questions to a plurality of learners (step S21). The acquisition unit 111 acquires a plurality of pieces of emotion data of the plurality of learners from the emotion data generation apparatus (step S22). The emotion data acquisition unit 111 may acquire the generated emotion data whenever the emotion data generation apparatus generates the emotion data, or may collectively acquire the emotion data at a plurality of different times.

Subsequently, the reception unit 112 receives response data of the plurality of learners to the examination question (step S23). The reception unit 112 may receive such response data for each predetermined number of examination questions (for example, 5 questions). The reception unit 112 may receive the response data after one chapter of the learning content ends.

Subsequently, the analysis data generation unit 113 generates analysis data for the learning from the emotion data received from the emotion data acquisition unit 111 and the response data received from the reception unit 112 (step S23). The emotion data from the plurality of learners can be relatively compared to be able to generate, for example, analysis data in which a learner who takes an abnormal behavior is identified. It is also possible to generate analysis data in which a learner whose degree of understanding is low is identified after relative comparison between a plurality of pieces of response data and identifying of difficulty levels of questions.

Subsequently, the content control unit 114 selects content corresponding to the analysis data from the content data 121 of the storage unit 120 (step S24). Further, the content control unit 114 stores the selected content in the analysis result storage area 122 of the storage unit 120 so that the selected content can be output (step S25).

The processes performed by the analysis apparatus 100 has been described above. Of the above-described processes, the order of steps S22 and S23 does not matter. Further, steps S22 and S23 may be executed in parallel. Alternatively, steps S22 and S23 may be alternately executed every predetermined period.

As described above, the analysis apparatus 100 according to the second example embodiment acquires the emotion data and the response data of the learners in the online learning and generates analysis data for the learning. Then, the analysis apparatus 100 can select and output content corresponding to the analysis data. Accordingly, the learners can learn with more optimum content. Accordingly, a manager using the analysis apparatus 100 can grasp the analysis result by an alert corresponding to the analysis data in the online learning. Accordingly, according to the example embodiment, it is possible to provide the analysis apparatus, the analysis method, the analysis system, and the program for effectively operating the online learning.

The analysis apparatus 100 includes a processor and a storage device as a configuration (not illustrated). The storage device included in the analysis apparatus 100 includes a storage device including a non-volatile memory such as a flash memory or an SSD. The storage device included in the analysis apparatus 100 stores a computer program (hereinafter also simply referred to as a program) executing the analysis method according to the example embodiment. The processor also reads a computer program from the storage device to the memory and executes the program.

Each configuration of the analysis apparatus 100 may be implemented with dedicated hardware. Some or all of the constituents may be implemented by general-purpose or dedicated circuitry, a processor, or the like, or a combination thereof. These units may be configured with a single chip or may be configured with a plurality of chips connected via a bus. Some or all of the constituents of each apparatus may be implemented in a combination of the above-described circuit or the like and a program. As the processor, a central processing unit (CPU), a graphics processing unit (GPU), a field-programmable gate array (FPGA), or the like can be used.

When some or all of the constituents of the analysis apparatus 100 are implemented with a plurality of computation apparatuses, circuits, and the like, the plurality of computation apparatuses, circuits, and the like may be disposed in a centralized manner or in a distributed manner. For example, the computation apparatuses, the circuits, and the like may be implemented in a form in which each of them is connected via a communication network, such as a client server system or a cloud computing system. The function of the analysis apparatus 100 may be provided in software as a service (Saas) format.

### Third Example Embodiment

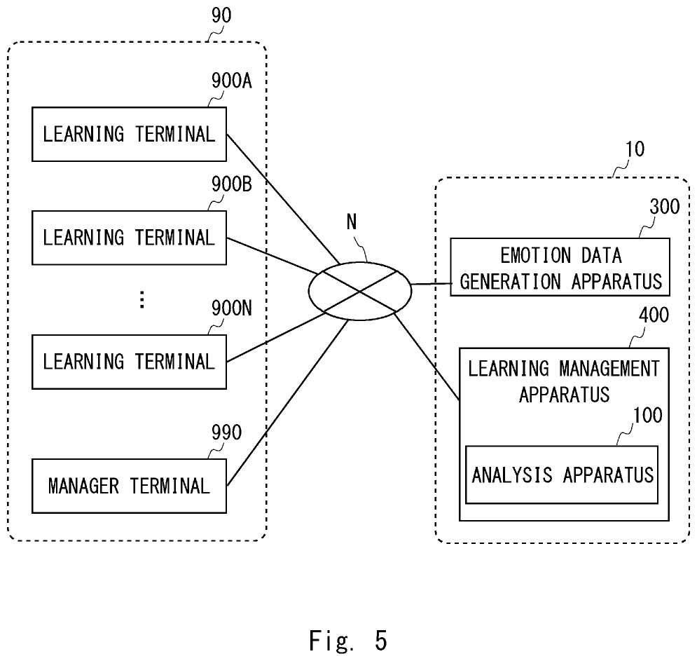

FIG. 5 is a block diagram illustrating a configuration of an analysis system according to a third example embodiment. An analysis system 10 illustrated in FIG. 5 includes a learning management apparatus 400 including an analysis apparatus 100 and an emotion data generation apparatus 300. The learning management apparatus 400 and the emotion data generation apparatus 300 are communicably connected to each other via a network N. The learning management apparatus 400 is connected to a learning terminal group 90 via the network N to operate the online learning. The learning terminal group 90 includes a plurality of learning terminals (900A, 900B, . . . , 900N) and a manager terminal 990.

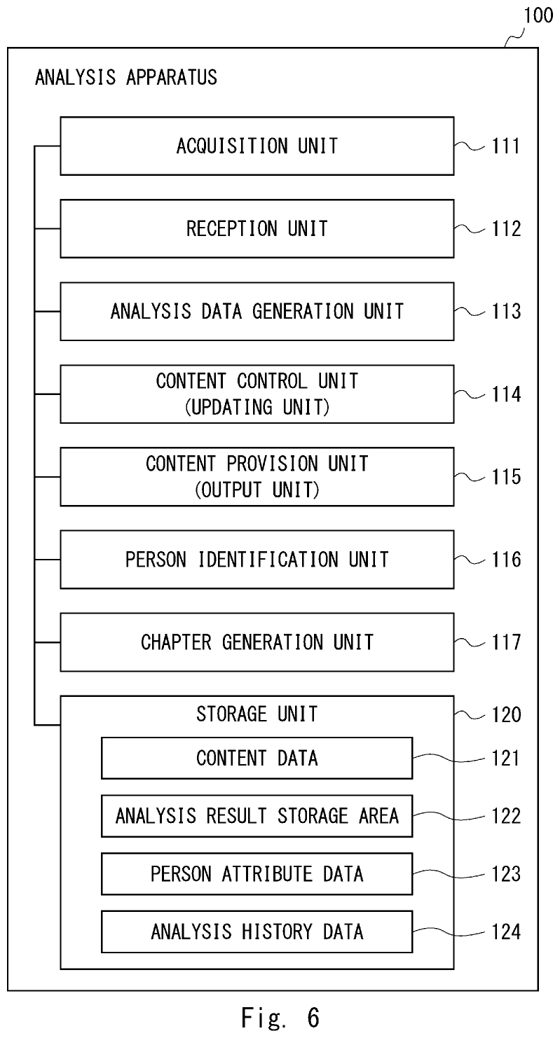

Next, an analysis apparatus according to a third example embodiment will be described with reference to FIG. 6. FIG. 6 is a block diagram illustrating a configuration of the analysis apparatus 100 according to the third example embodiment. The analysis apparatus 100 according to the third example embodiment is different from the analysis apparatus 100 according to the second example embodiment in that a person identification unit 116 and a chapter generation unit 117 are included. Hereinafter, each configuration of the analysis apparatus 100 according to the example embodiment will be described including different points from those of the analysis apparatus 100.

The acquisition unit 111 acquires emotion data in which a plurality of indices indicating states of emotions are indicated in numerical values by using a video analysis technique of an image obtained by capturing the learners. The acquisition unit 111 can also acquire the face image data of the learners requiring the emotion data. The analysis data generation unit 113 generates analysis data by calculating statistical values of the emotion data during a predetermined period. The emotion data acquisition unit 111 can acquire emotion data including identification information of the learning terminal. That is, in this case, the emotion data acquisition unit 111 can acquire the respective emotion data of the learners in a distinguishable manner.

The emotion data acquisition unit 111 can acquire the emotion data involving time data related to the learning. Since the emotion data involves the time data, the emotion data acquisition unit 111 can acquire, for example, emotion data for generating analysis data for each chapter, as will be described below.

In another example embodiment, the acquisition unit 111 further includes a motion analysis unit that analyzes motions of the learners from the images of the learners. In still another example embodiment, the acquisition unit 111 can use a facial action coding system (FACS) theory that recognizes and codes motions of face expression muscles and defines face expression motions and emotions. Further, the acquisition unit 111 can acquire a result obtained by estimating a heart rate and wakefulness of the learners in front of the camera using remote photoplethysmography (PPG).

The reception unit 112 receives a response results (for example, correct or incorrect) of the learners to learning content (for example, examination questions) from the learning terminals. The reception unit 112 acquires identification information and attribute data (for example, a class, a grade, and the like) of the learners. The reception unit 112 can measure a time from presentation of the learning content (for example, examination questions) to an input of the responses.

The reception unit 112 can identifiably acquire the response result and the response time of each learner from the plurality of learning terminals.

The analysis data generation unit 113 generates analysis data for the learning from the received emotion data, response result, and response time. The analysis data generation unit 113 can generate analysis data for the learning for each chapter from data indicating a chapter received from the chapter generation unit 117.

The analysis data generation unit 113 can analyze a learning situation of the learner by using the emotion data obtained by performing the emotion analysis based on the face image of the learner (that is, by using a video analysis technique,). For example, it is possible to grasp that the learner cannot keep up with learning from a confused expression of the learner. Alternatively, it is possible to grasp a decrease in the degree of concentration from a motion of a visual line of the learner or the like. The analysis data generation unit 113 can recognize and encode the motions of the face expression muscles and use a facial action coding system (FACS) theory that defines face expression motions and emotions. Further, the analysis data generation unit 113 can estimate a heart rate and wakefulness of the learner in front of the camera using remote photoplethysmography (PPG). Further, the analysis data generation unit 113 can grasp a time at which the visual line of the learner in front of the camera is off a screen.

The analysis data generation unit 113 can further determine the degree of understanding of the learning content from the response result and the response time of the learner acquired from the reception unit 112 as information other than the video. For example, when the response result of the learner is correct and the response time is shorter than a threshold, the learner can determine that the degree of understanding of the content is high. Conversely, when the response result of the learner is incorrect and the response time is longer than the threshold, the learner can determine that the degree of understanding of the content is low. The analysis data generation unit 113 supplies the analysis data generated as described above to the content control unit 114.

The analysis data generation unit 113 can generate analysis data including a relative comparison result corresponding to the attribute data of the learning or the learner from the attribute data of the learning or the learner and the analysis history data 124 stored in the storage unit 120. That is, the analysis data generation unit 113 extracts the analysis data having the attribute data corresponding to the attribute data included in the learning data related to the analysis from the analysis history data 124 and generates the relative comparison result.

The analysis data generation unit 113 can also generate the analysis data based on a relative comparison of emotion data, the response results, and the response times for the plurality of learners. The analysis data generation unit 113 may preferentially extract latest data from the analysis history data 124. The analysis data generation unit 113 may calculate statistical values of scores of the analysis data in the corresponding attribute data from the analysis history data 124 and then perform relative comparison.

When data indicating a chapter is generated for the learning, the analysis data generation unit 113 can generate analysis data for the learning for each chapter. Accordingly, the learning management apparatus 400 including the analysis apparatus 100 can generate the analysis data for each chapter and supply content corresponding to the generated analysis data.

When the analysis data received from the analysis data generation unit 113 includes a plurality of analysis items, the content control unit 114 can select content based on the analysis items. For example, when the analysis data includes scores for the analysis items of the degree of concentration, the degree of empathy, and the degree of understanding, the content control unit 114 can select content appropriate for the scores of the degree of concentration, the degree of empathy, and the degree of understanding. Accordingly, the analysis apparatus 100 can supply detailed content to the learner.

When the analysis data exceeds a range of a preset threshold, the content control unit 114 can select content in which the analysis data falls within the range of the threshold. For example, it is assumed that the analysis data generation unit 113 generates a score of “the degree of understanding” which is an analysis item in numerical values from 0 to 100, and the larger the numerical value is, the higher the degree of understanding of a participant is. It is assumed that the content control unit 114 sets a threshold of 50 for the degree of understanding. In this case, when the analysis data of the degree of understanding is less than 50, the content control unit 114 selects content (for example, content that is easily understood by a learner whose degree of understanding is low) for making the score higher than 50 from the content stored in the content data 121. For example, in this case, when the content is examination questions, the content data 121 stores questions with different difficulty levels. For a learner of whose degree of understanding is low, the content control unit 114 can select the examination questions with low difficulty levels as the content.

When the content including the examination questions is the online lesson content, various types of online lesson content after the examination questions are stored in the content data. For example, different types of online lesson content include content in various description ways and content with different reproduction rates. For example, when the analysis data of the degree of understanding is less than 50, the content control unit 114 selects content (for example, content which has a relatively low reproduction rate at which a learner whose degree of understanding is low can easily understand) for making the score higher than 50 from the content stored in the content data 121. In such a configuration, the analysis apparatus 100 can supply content for performing effective learning for the user.

When the analysis data is generated for each chapter, the content control unit 114 selects content for each piece of the generated analysis data for each chapter. Accordingly, the analysis apparatus 100 can supply optimum content for each chapter.

The person identification unit 116 can have a function of extracting face feature information of a person related to the face image from the face image data and estimating a division to which the person belongs in accordance with to the extracted information. The division to which the person belongs indicates a feature or an attribute of the person, for example, an age or sex of the person. The person identification unit 116 uses the above-described function to identify a division to which the participant belongs in the face image data received from the acquisition unit 111. The person identification unit 116 supplies data regarding the division of the person to the analysis data generation unit 113.

In addition, the person identification unit 116 may identify a division to which the identified participant belongs using person attribute data 123 stored in the storage unit 120. In this case, the person identification unit 116 associates the face feature information extracted from the face image with the person attribute data 123, and identifies the division of participants corresponding to the face feature information. The division of the participants in this case is, for example, a school to which the learner belongs, a class in the school, or the like. In such a configuration, the analysis apparatus 100 can extract data available for the analysis data while taking privacy of the learner into consideration.

The person identification unit 116 may identify a person related to the face image from the face image data received from the reception unit 112. In this case, the person identification unit 116 associates the face feature information extracted from the face image with the person attribute data 123 stored in the storage unit 120, and identifies the participant corresponding to the face feature information. Accordingly, the person identification unit 116 can identify each of the participants in the learning. By identifying the participant of the learning, the analysis apparatus 100 can generate the analysis data associated with the identified participant. Accordingly, the analysis apparatus 100 can perform detailed analysis on the identified participant.

The chapter generation unit 117 generates a chapter for the learning from the learning content data received from the content provision unit 115. The chapter generation unit 117 detects, for example, a time from start of the learning to end of the learning, further detects a time matching a preset condition, and generates data indicating the chapter using each time as a division. The chapter of the learning in the present disclosure is defined by whether a state matching the predetermined condition is maintained in the learning or whether the predetermined condition is changed. The chapter generation unit 117 may generate a chapter based on, for example, examination questions included in the content. More specifically, the chapter generation unit 117 may generate a chapter in accordance with a content switching timing after the examination questions. Alternatively, a chapter may be generated for every plurality of examination questions (for example, every five questions). The chapter generation unit 117 supplies data indicating the generated chapter to the analysis data generation unit 113.

The storage unit 120 is a storage apparatus including a non-volatile memory such as an SSD or a flash memory. The storage unit 120 stores the person attribute data 123 and the analysis history data 124 in addition to the content data 121 and the analysis result storage area 122.

The person attribute data 123 is data in which face feature information of a person is associated with information regarding a division and an attribute of the person. Examples of the information regarding the division and attribute of the person include, but are not limited to, a name, a sex, an age, a school to which the person belongs, a company to which the person belongs, and a job category of the person.

The analysis history data 124 is analysis data related to analysis performed by the analysis apparatus 100 in the past, that is, analysis data generated by the analysis data generation unit 113 of the analysis apparatus 100 in the past. In addition to the above-described data, the storage unit 120 stores, for example, a program executing an analysis method according to the example embodiment.

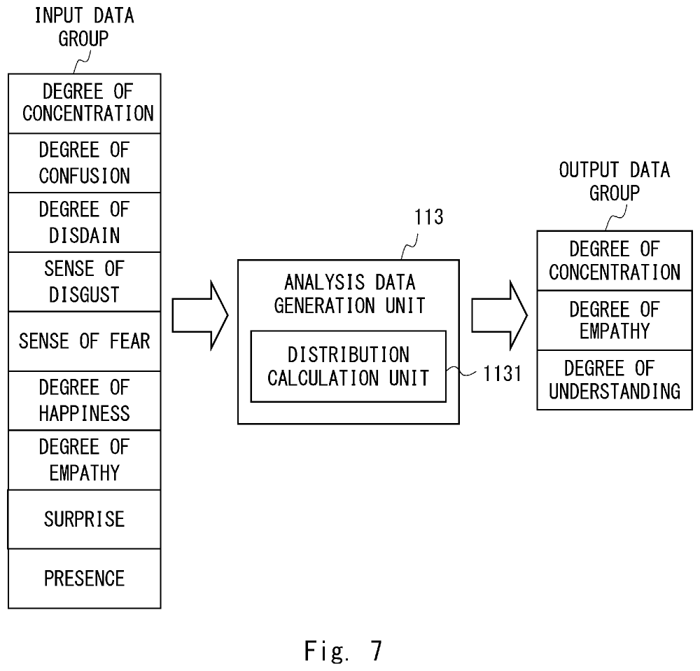

The analysis data generation unit 113 will be described in more detail with reference to FIG. 7. FIG. 7 is a diagram illustrating an example of data processed by the analysis data generation unit. FIG. 7 illustrates an input data group received by the analysis data generation unit 113 and an output data group output by the analysis data generation unit 113. The analysis data generation unit 113 receives emotion data as an input data group from the emotion data generation apparatus 300. The input data group includes, for example, indices related to the degree of concentration, the degree of confusion, the degree of disdain, a sense of disgust, a sense of fear, the degree of happiness, anxiety, the degree of empathy, a surprise, and presence. These indices are indicated, for example, by numerical values from 0 to 100. The index illustrated here indicates that, for example, the larger the value is, the greater a reaction of the learner to the emotion is. The emotion data of the input data group may be generated from the face image data using a known video analysis technique or may be generated and acquired by another method.

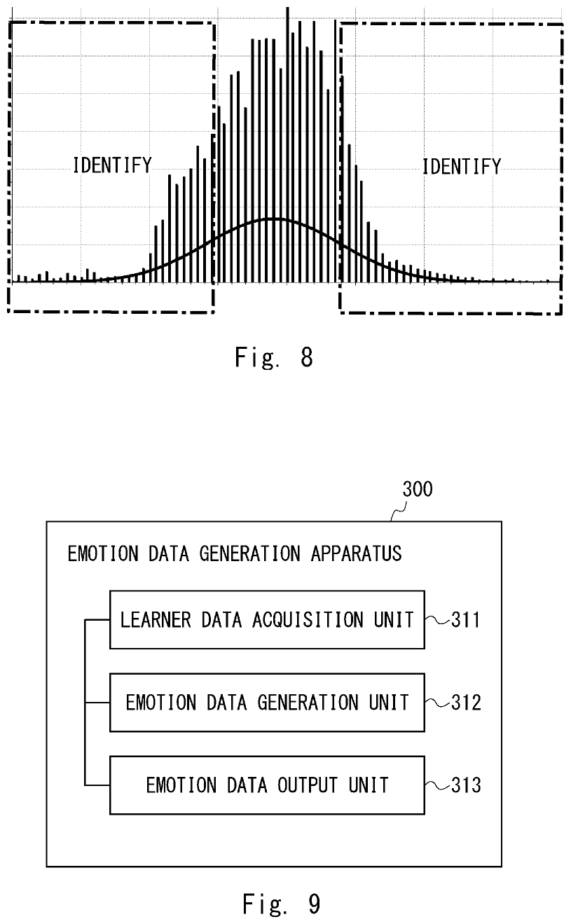

Further, the analysis data generation unit 113 includes a distribution calculation unit 1131. The distribution calculation unit 1131 calculates a distribution for specific emotion data from emotion data of the plurality of learners. FIG. 8 illustrates an example of the distribution for the specific emotion data calculated from the emotion data of the plurality of learners. In FIG. 8, the horizontal axis represents the degree of concentration and the vertical axis represents the number of students. The distribution calculation unit 1131 can identify a range exceeding a predetermined threshold (for example, a standard deviation σ, 2σ, 3σ, or the like) from an average value. The distribution calculation unit 1131 can identify an upper limit range (exceeding, for example, the standard deviation σ), a lower limit range (less than, for example, a standard deviation −σ.) or both the upper limit range and the lower limit range. For example, there is a case in which analysis data in which a student who has a low degree of understanding falling within a lower limit range of the distribution is identified is generated. There is also a case in which analysis data in which a student who has an average degree of understanding falling within a range from a lower limit value to an upper limit value of the distribution is identified is generated. Furthermore, there is a case in which analysis data in which a student who has a high degree of understanding within the upper limit range of the distribution is identified is generated. In this way, by statistically analyzing the emotion data of the plurality of learners, it is possible to identify a learner who takes an abnormal action. The abnormal behavior is, for example, but are not limited to, poor concentration, a failure to keep up with a class, and a suspicion of a cheating behavior.

The number of the plurality of learners can be a number corresponding to at least one class (for example, 20 or more, 30 or more, 100 or more, or any appropriate number or more) or a number corresponding to at least the first grade (for example, 100 or more, 200 or more, or any appropriate number or more).

Alternatively, the analysis data generation unit 113 can calculate an accuracy rate of the learners for certain questions and determine difficulty levels of the questions. For example, when a certain learner has made a mistake in a question even though an accuracy rate of the question of all the learners in one class exceeds 70% (that is, an easy problem), it can be determined that the learner does not to understand the question. On the other hand, for example, when an accuracy rate of a question of all the learners of one class is less than 30% (that is, a difficult problem), even if a certain learner has made a mistake in the question, it may not be determined that the learner does not to understand the question.

When the above-described input data group is received, the analysis data generation unit 113 performs a preset process and generates an output data group using the input data group. The output data group is data that is referred to by a user who uses the analysis system 10 to efficiently perform the learning. Examples of the output data group include the degree of concentration, the degree of empathy, and the degree of understanding. The analysis data generation unit 113 extracts a preset index from the input data group. The analysis data generation unit 113 performs a preset calculation process on a value regarding the extracted index. Then, the analysis data generation unit 113 generates the above-described output data group. The degree of concentration indicated as the output data group may be the same as or different from the degree of concentration included in the input data group. Similarly, the degree of empathy indicated as the output data group may be the same as or different from the degree of empathy included in the input data group.

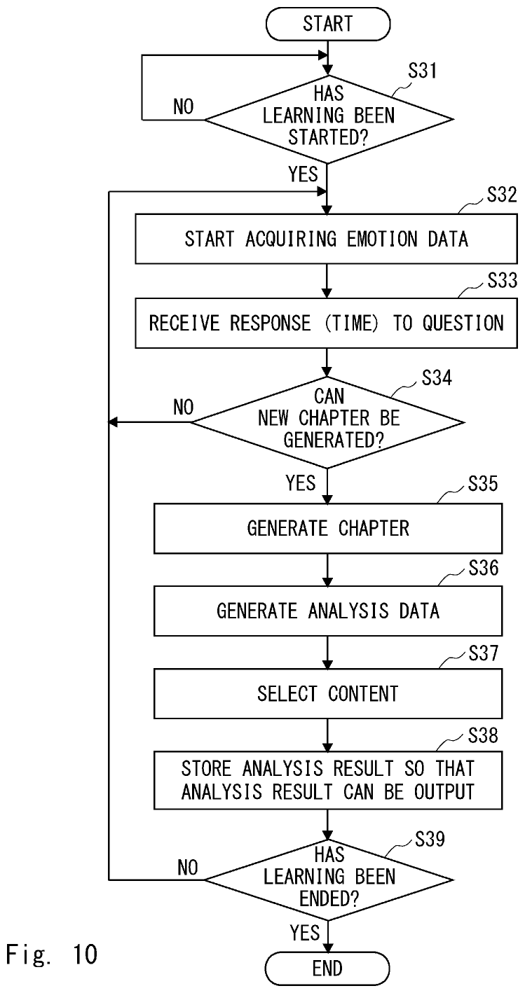

FIG. 9 is a block diagram illustrating a configuration of an emotion data generation apparatus according to the third example embodiment. The emotion data generation apparatus 300 includes a learner data acquisition unit 311, an emotion data generation unit 312, and an emotion data output unit 313 as main constituents.

The learner data acquisition unit 311 acquires data regarding the learners from the learning management apparatus 400. The data regarding the learners is face image data of the learners captured by the learning terminal. The emotion data generation unit 312 generates emotion data from the face image data received by the emotion data generation apparatus 300. The emotion data output unit 313 outputs the emotion data generated by the emotion data generation unit 312 to the analysis apparatus 100 via the network N. The emotion data generation apparatus 300 generates emotion data by performing predetermined image processing on the face image data of the learners. The predetermined image processing is, for example, extraction of feature points (or features), comparison of the extracted feature points with reference data, a convolution process of image data, a process using training data trained by machine learning, a process using training data by deep learning, and or like. However, a scheme by which the emotion data generation apparatus 300 generates the emotion data is not limited to the above-described processes. The emotion data may be a numerical value that is an index indicating an emotion or may include image data used to generate the emotion data.

The learner data acquisition unit 311 may additionally acquire biological information such as a heart rate and a pulse from a wearable apparatus (for example, a smartwatch) worn by the learner.

The data related to the learner may include data for distinguishing the learners from each other. For example, the data regarding the learners may include identifiers of learning terminals capturing the face image data of the learners. Accordingly, the emotion data generation unit 312 can generate the emotion data in a state in which the learners can be distinguished from each other. Then, the emotion data output unit 313 generates the emotion data corresponding to the learning terminals so that the learning terminals can be distinguished from each other and supplies the emotion data to the emotion data acquisition unit 111.

The emotion data generation apparatus 300 includes a processor and a storage device as a configuration (not illustrated). The storage device included in the emotion data generation apparatus 300 stores a program executing emotion data generation according to the example embodiment. The processor also reads a program from the storage device to the memory and executes the program.

Each configuration of the emotion data generation apparatus 300 may be implemented with dedicated hardware. Some or all of the constituents may be implemented by a general-purpose or dedicated circuit, processor, or the like, or a combination thereof. These units may be configured with a single chip or may be configured with a plurality of chips connected via a bus. Some or all of the constituents of each apparatus may be implemented in a combination of the above-described circuit or the like and a program. As the processor, a CPU, a GPU, an FPGA, or the like can be used.

When some or all of the constituents of the emotion data generation apparatus 300 are implemented by a plurality of computation apparatuses, circuits, and the like, the plurality of computation apparatuses, circuits, and the like may be disposed in a centralized manner or in a distributed manner. For example, the computation apparatuses, the circuits, and the like may be implemented in a form in which each of them is connected via a communication network, such as a client server system or a cloud computing system. The function of the emotion data generation apparatus 300 may be provided in a Saas format.

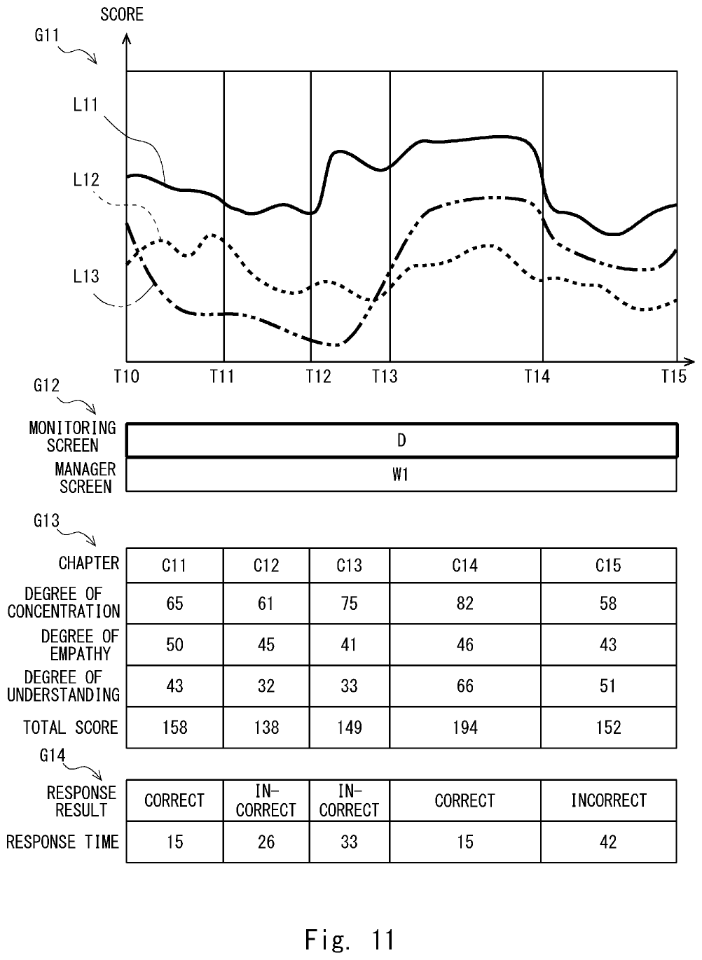

Next, a process executed by the analysis apparatus 100 will be described with reference to FIG. 10. FIG. 10 is a flowchart illustrating an analysis method according to the third example embodiment. The process illustrated in FIG. 10 is different from the process according to the second example embodiment in that analysis data is output whenever a new chapter is generated in the learning.

First, the analysis apparatus 100 determines whether the online learning has been started (step S31). The analysis apparatus 100 determines whether the learning (for example, a class or an examination) has been started by receiving a signal indicating that learning is started from learning management apparatus 400. The content provision unit 115 supplies learning content to one or a plurality of learning terminals in real time. When it is determined that the online learning has not been started (NO in step S31), the analysis apparatus 100 repeats step S31. When it is determined that the online learning has been started (YES in step S31), the analysis apparatus 100 moves to step S32.

In step S32, the emotion data acquisition unit 111 starts acquiring the emotion data of one or the plurality of learners from the emotion data generation apparatus (step S32). The emotion data acquisition unit 111 may acquire the generated emotion data whenever the emotion data generation apparatus generates the emotion data, or may collectively acquire the emotion data at a plurality of different times.

Subsequently, the reception unit 112 receives the learning data regarding responses and response times of one or the plurality of learners to the examination questions during the online learning (step S33). The reception unit 112 may receive the learning data for every predetermined number of questions or sequentially receive the learning data for each examination question.

Subsequently, the analysis apparatus 100 determines whether a new chapter can be generated from the received learning data (step S34). When it is not determined that the new chapter can be generated (NO in step S34), the analysis apparatus 100 returns to step S32. Conversely, when it is determined that the new chapter can be generated (YES in step S34), the analysis apparatus 100 moves to step S35.

In step S25, the chapter generation unit 117 generates a chapter from the learning data received from the reception unit 112 (step S35).

Subsequently, the analysis data generation unit 113 generates analysis data for the newly generated chapter from the emotion data received from the emotion data acquisition unit 111, the response result (after the generation) and the response time received from the reception unit 112, the data indicating the chapter received from the chapter generation unit 117, and the data received from the person identification unit 116 (step S36). It is also possible to generate analysis data in which a learner who takes an abnormal action is identified based on a distribution of the emotion data of the plurality of learners. For example, it is also possible to generate analysis data in which a learner with a high degree of understanding, a learner with a medium degree of understanding, and a learner with a low degree of understanding are identified.

Subsequently, the content control unit 114 selects content corresponding to the analysis data from the content data 121 of the storage unit 120 (step S37). Further, the content control unit 114 stores the analysis result including the selected content in the analysis result storage area 122 of the storage unit 120 so that the analysis result can be output (step S38). For example, first content (for example, class content with a high reproduction rate or an examination question with a high difficulty level) is selected for the learner with the high degree of understanding, second content (for example, class content with a medium reproduction rate or an examination question with a medium difficulty level) is selected for the learner with the medium degree of understanding, and third content (for example, class content with a slow reproduction rate or an examination question with a low difficulty level) is selected for the learner with the low degree of understanding.

Subsequently, the analysis apparatus 100 determines whether the learning has been completed (step S39). The analysis apparatus 100 determines whether the learning has ended by receiving a signal indicating that the learning has been completed from the learning management apparatus 400. When it is determined that the learning has not been ended (NO in step S39), the analysis apparatus 100 returns to step S32 and continues the process. Conversely, when it is determined that the online learning has ended (YES in step S39), the analysis apparatus 100 ends the series of processes.

The process of the analysis apparatus 100 according to the third example embodiment has been described above. According to the above-described flowchart, the analysis apparatus 100 generates the analysis data for a chapter generated whenever a new chapter is generated in the learning, and can select the content corresponding to the generated analysis data. Accordingly, a learner using the analysis system 10 can effectively proceed with the learning using the optimum content supplied whenever the new chapter is generated in the learning which is being reproduced.

Next, an example of the analysis data generated by the analysis data generation unit 113 will be described with reference to FIG. 11. FIG. 11 is a diagram illustrating an example of the analysis data. FIG. 11 illustrates a graph G11 showing the analysis data along the time series in the uppermost row. The graph G11 shows transition of analysis data of a certain student. In the middle upper part, monitoring screen data G12 corresponding to the above time series is illustrated. The learning data indicates a monitoring screen on which the face of a student in a class is captured and a manager screen (a screen can also be switched to a screen on which a textbook, a blackboard, an examination question, or the like is captured) on which a speaker (mainly, a teacher) is captured. Analysis data G13 for each chapter corresponding to the graph G11 is illustrated in the middle lower part. The chapter is generated whenever the manager presents an examination question for measuring the degree of understanding of the class to the student. In the lowermost part, response data G14 indicating a response result and a response time to an examination question of a student is illustrated.

In the graph G11, the horizontal axis represents time and the vertical axis represents a score of the analysis data. On the horizontal axis, the left end is time T10, the time passes as it goes to the right, and the right end is time T15. Time T10 is a start time of the learning, and time T15 is an end time of the learning. Times T11, T12, T13, and T14 between time T10 and time T15 indicate times corresponding to chapters to be described below.

In the graph G11, first analysis data L11 presented by a solid line, second analysis data L12 represented by a dotted line, and third analysis data L13 represented by a two-dot chain line are plotted. The first analysis data L11 indicates the degree of concentration in the analysis data. The second analysis data L12 indicates the degree of empathy in the analysis data. The third analysis data L13 indicates the degree of understanding in the analysis data.

In the learning data G12, data regarding the learner monitoring screen during the class and data regarding the manager screen are illustrated chronologically. In the data regarding the learner monitoring screen, a face image of a certain student D is displayed. In the learning data G12, the data regarding the manager indicates that, from time T10 to time T15, a manager W1 (for example, a teacher or a test supervisor) was shown.

A relationship between the monitoring screen and the manager screen (for example, mainly, a teacher,) in the above-described learning data G12 will be described chronologically. From time T10 to time T15, a face image of each student is displayed on the monitoring screen.

As described above, the learning data illustrated in FIG. 11 includes data during a period in which the screen data on the monitoring screen has been displayed and data for the manager screen indicating who the manager is. The chapter generation unit 117 generates a chapter in accordance with data related to the manager screen among the above-described learning data. A chapter may be generated even at a timing at which the manager who is a teacher switches to a screen on which the textbook, the blackboard, the examination question, or the like is captured.

As illustrated in FIG. 11, the analysis data G13 includes analysis data corresponding to each chapter. The analysis data (also referred to as emotion analysis data) indicates the degree of concentration, the degree of empathy, the degree of understanding, and a total score obtained by summing the degree of concentration, the degree of empathy, the degree of understanding. In the analysis data G13, for example, as the analysis data corresponding to the chapter C11, the degree of concentration is 65, the degree of empathy is 50, and the degree of understanding is 43. In the total score, 158 is shown as the sum of these scores. Similarly, for example, as the analysis data corresponding to the chapter C12, the degree of concentration is 61, the degree of empathy is 45, the degree of understanding is 32, and the total score is 138.

The analysis data corresponds to data plotted in the graph G11. That is, the analysis data indicated as the analysis data G13 is an average value of the analysis data calculated every predetermined period (for example, 1 minute) in a period of the corresponding chapter.

The response data G14 indicates a response result and a response time for an examination question of a certain learner. Examination Question 1 in chapter C11 is correct, and its response time is 15 seconds. Examination Question 2 in chapter C12 is incorrect, and its response time is 26 seconds. Examination Question 3 in chapter C13 is incorrect, and its response time is 33 seconds. Examination Question 4 in chapter C14 is correct, and its response time is 15 seconds. Examination Question 5 in chapter C15 is incorrect, and its response time is 42 seconds.

The example of the analysis data has been described above. In the example illustrated in FIG. 11, the chapter generation unit 117 sets a timing at which a supervisor presents the examination problems to the students as a chapter switching timing. Then, the analysis data generation unit 113 calculates analysis data from start of learning to end of learning for each chapter described above. Accordingly, the analysis system 10 can supply the analysis data of the degree of understanding of the examination questions of the learners.

In the example illustrated in FIG. 11, the analysis system 10 calculates and plots the analysis data every predetermined period as illustrated in the above-described graph G11. Accordingly, the analysis system 10 can show a detailed change in the analysis data in the learning. However, instead of the calculation as illustrated in the graph G11, the analysis data generation unit 113 may first calculate a statistical value (for example, an average value) of the emotion data in the chapter after end of the chapter, and then calculate the analysis data. For example, as illustrated in FIG. 8, the distribution can be calculated in order to relatively compare the emotion data of each learner. A range exceeding a predetermined threshold (for example, the standard deviation σ, 2σ, 3σ, or the like) from the average value can be identified from the distribution.

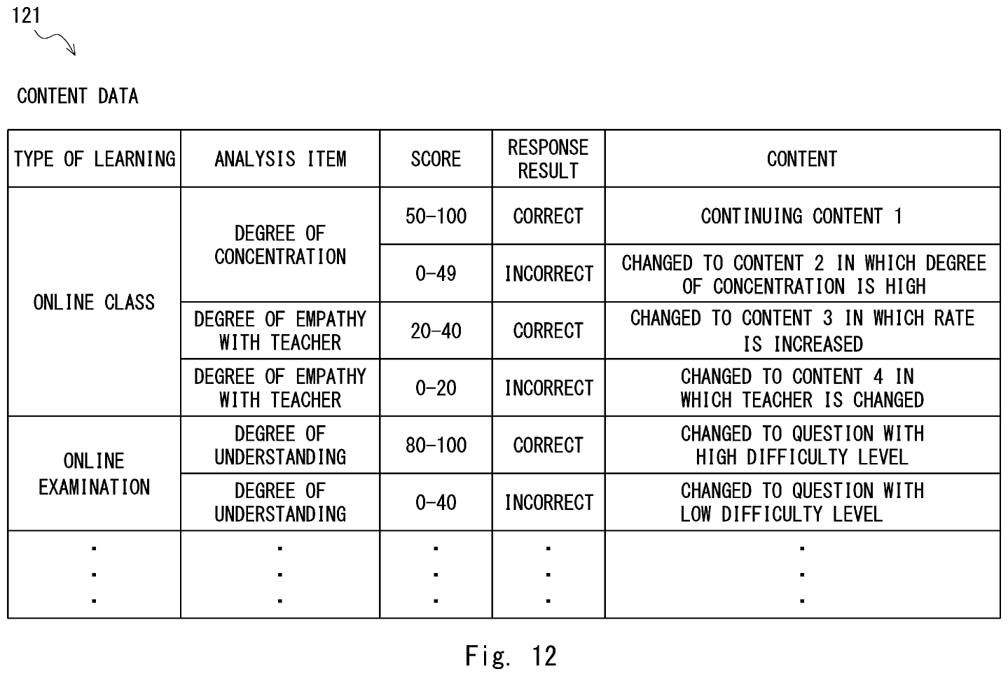

Next, the content data 121 will be described with reference to FIG. 12. FIG. 12 is a diagram illustrating an example of content data. A table illustrated in FIG. 12 illustrates a type of learning, an analysis item, a score, and an alert.

The type of learning is an item included in the attribute data of the learning, and is an item for classifying the learning into a preset type. In the content data 121 illustrated in FIG. 12, items of “online class” and “online examination” are illustrated as types of learning. The type of learning may include, for example, specific subjects such as “mathematical online class” and “English online examination”, but is not limited to the above items.

In the content data 121 illustrated in FIG. 12, “the degree of concentration” and “the degree of empathy” are indicated as analysis items corresponding to “online class”. This indicates that, in the learning in which the type of learning is classified as the online examination, the content is selected focusing on the “degree of concentration” and the “degree of empathy” among the analysis items included in the analysis data.

In the table illustrated in FIG. 12, scores “50-100” and scores “0-49” are illustrated on the right side of the “degree of concentration”. On the right side of each score, the response result of the student to the examination question is illustrated. On the right side of each score and response result, corresponding content is illustrated. When a response of the student to an examination question is “correct” with the score of “50-100”, content 1 is continued. On the other hand, when the score is “0-49” and the response of the student to the examination question is “incorrect”, the content is changed to content 2 for enhancing the degree of concentration.

When degree of empathy of the student with the teacher is “20-40” and the response of the student to the examination question is “correct”, the content is changed to content 3 in which the same teacher conducts the class but the reproduction rate is increased. On the other hand, when the degree of empathy of the student with the teacher is “0-20” and the response of the student to the examination question is “incorrect”, the content is changed to content 4 in which the changed teacher conducts a class.

Furthermore, in the column under the type of learning “online class”, “online examination” is displayed. In the analysis item corresponding to the online examination, “the degree of understanding” is indicated. For each “degree of understanding”, a response result of the student to the examination question is shown. When the score corresponding to the degree of understanding is “80-100” and the response of the student to the examination question is “correct”, the question is changed to a question with a high difficulty level. On the other hand, when a score corresponding to the degree of understanding is “0-40” and the response of the student to the examination question is “incorrect”, the problem is changed to a problem with a low difficulty level.

As described above, in the example illustrated in FIG. 12, the type of learning, the analysis item, the score of the analysis item, the response result, and the content are stored in association with each other in the content data 121. The content control unit 114 compares the response data received from the reception unit 112, the analysis data received from the analysis data generation unit 113, and the content data 121, and selects corresponding content. Accordingly, the analysis apparatus 100 can supply the learner with content appropriately selected in accordance with the learning attribute data, the score of the analysis data, and the like. The content data 121 may adopt, for example, a subject of the learning, a purpose of the learning, or the like, in addition to the type of learning, as the attribute data of the learning.

Although the third example embodiment has been described above, the analysis system 10 according to the third example embodiment is not limited to the above-described configuration. For example, the content provision unit may adjust a timing at which the content is supplied based on an Ebbinghaus's forgetting curve. In this case, a proficiency level of the learner is estimated from the emotion data and the response data. When a memory retention rate of the learner is a threshold (for example, 20%) or less, the content control unit selects content for recovering the memory. Then, the content provision unit can supply the selected content at an appropriate timing. A forgetting curve specific to the learner may be estimated, and content may be supplied at an appropriate timing according to the forgetting curve.

Alternatively, a timing at which the content is supplied may be set with reference to a theory that represents a relationship between performance and tension, which is called the Yerkes-Dodson law. For example, the content control unit may select a question with a high difficulty level while the degree of concentration of the learner is high. When the degree of concentration of the learner has decreased, the content control unit may select a question at which the learner is good. To prevent a decrease in motivation in the online learning, content with an appropriate sense of tension may be supplied.

The content control unit may select content that alleviates visual pressure when a fatigue of the learner has decreased. Methods for mitigating visual pressure include adjusting contrast, eliminating corners of the chart, increasing spacing between letters, and the like.

The above-described program can be stored and supplied to a computer using any of various types of non-transitory computer readable media. The non-transitory computer readable media include various types of tangible storage media. Examples of the non-transitory computer readable media include a magnetic recording medium (for example, a flexible disk, a magnetic tape, or a hard disk drive), a magneto-optical recording medium (for example, a magneto-optical disc), a compact disc-read only memory (CD-ROM), a CD-R, a CD-R/W, and a semiconductor memory (for example, a mask ROM, a programmable ROM (PROM), an erasable PROM (EPROM), a flash ROM, or a random access memory (RAM)). The program may be supplied to the computer using any of various types of transitory computer readable media. Examples of the transitory computer readable media include an electrical signal, an optical signal, and an electromagnetic wave. The transitory computer-readable media can supply programs to computers via a wired communication path such as electric wires and optical fibers, or wireless communication paths.

The present invention is not limited to the foregoing example embodiments, and can be appropriately changed without departing from the gist of the present invention.

Some or all of the foregoing example embodiments may be described as the following supplementary notes, but are not limited to the followings.

### (Supplementary Note 1)

An analysis apparatus including:
a content provision unit configured to supply a learner with content including an examination question;
an acquisition unit configured to acquire emotion data regarding learning of the learner for which an emotion analysis has been performed on face image data of the learner who learns using the content;
a reception unit configured to receive a response of the learner to the examination question; and
a content control unit configured to control subsequent content based on the acquired emotion data and a result of the response.

### (Supplementary Note 2)

The analysis apparatus according to Supplementary note 1,
wherein the reception unit acquires a time required for a response along with the response of the learner to the examination question, and
wherein the content control unit changes the subsequent content based on the acquired emotion data, a result of the response, and a response time.

### (Supplementary Note 3)

The analysis apparatus according to Supplementary note 1 or 2, further including:
a motion analysis unit configured to analyze a motion of the learner from a video of the learner,
wherein the content control unit changes the subsequent content based on the acquired emotion data, the result of the response, and a motion analysis result.

### (Supplementary Note 4)

The analysis apparatus according to any one of Supplementary notes 1 to 3,
wherein the content provision unit supplies content to a plurality of the learners,
wherein the acquisition unit acquires the emotion data regarding the learning of each learner, the emotion data being obtained by performing emotion analysis on the face image data of each learner who learns using the content,
wherein the analysis apparatus further includes an analysis data generation unit configured to aggregate the emotion data regarding the plurality of learners based on the emotion data of each learner, compare the emotion data of the plurality of learners, and identify emotion data of one or more learners, and
wherein the content control unit changes the subsequent content for the one or more identified learners.

### (Supplementary Note 5)

The analysis apparatus according to Supplementary note 4,
wherein the reception unit receives response results of a plurality of the learners to the examination question,
wherein the analysis data generation unit aggregates the emotion data and the response data of each learner, compares the emotion data of the plurality of learners with a plurality of response results, and identifies the emotion data of one or more learners, and
wherein the content control unit controls content of the one or more identified learners.

### (Supplementary Note 6)

The analysis apparatus according to Supplementary note 5,
wherein the analysis data generation unit calculates a distribution related to a specific emotion and a distribution of a specific response result from the emotion data and the response data of the plurality of learners, and identifies one or more learners exceeding a deviation value based on the distributions, and
wherein the content control unit controls the content of the one or more identified learners.

### (Supplementary Note 7)

The analysis apparatus according to any one of Supplementary notes 1 to 6, wherein the content control unit selects content in accordance with a forgetting curve for specific content of a learner.

### (Supplementary Note 8)

The analysis apparatus according to any one of Supplementary notes 1 to 7, wherein the content control unit selects content with different difficulty levels, content with different reproduction rates, or content with different visual pressures.

### (Supplementary Note 9)

An analysis method including:
supplying a learner with content including an examination question;
acquiring emotion data regarding learning of the learner for which an emotion analysis has been performed on face image data of the learner who learns using the content;
receiving a response of the learner to the examination question; and
controlling subsequent content based on the acquired emotion data and a result of the response.

### (Supplementary Note 10)

An analysis program causing a computer to perform:
supplying a learner with content including an examination question;
acquiring emotion data regarding learning of the learner for which an emotion analysis has been performed on face image data of the learner who learns using the content;
receiving a response of the learner to the examination question; and
controlling subsequent content based on the acquired emotion data and a result of the response.

Although the invention of the present application has been described above with reference to the example embodiments, the invention of the present application is not limited to the above. Various modifications that can be understood by those skilled in the art can be made to the configuration and details of the invention of the present application within the scope of the invention.

This application claims priority based on Japanese Patent Application No. 2021-029037 filed on Feb. 25, 2021, the entire disclosure of which is incorporated herein.

### REFERENCE SIGNS LIST

10 ANALYSIS SYSTEM
90 LEARNING TERMINAL GROUP
100 ANALYSIS APPARATUS
111 ACQUISITION UNIT
112 RECEPTION UNIT
113 ANALYSIS DATA GENERATION UNIT
1131 DISTRIBUTION CALCULATION UNIT
114 CONTENT CONTROL UNIT
115 CONTENT PROVISION UNIT
116 PERSON IDENTIFICATION UNIT
117 CHAPTER GENERATION UNIT
120 STORAGE UNIT
121 CONTENT DATA
122 ANALYSIS RESULT STORAGE AREA
123 PERSON ATTRIBUTE DATA
124 ANALYSIS HISTORY DATA
300 EMOTION DATA GENERATION APPARATUS
311 LEARNER DATA ACQUISITION UNIT
312 EMOTION DATA GENERATION UNIT
313 EMOTION DATA OUTPUT UNIT
400 LEARNING MANAGEMENT APPARATUS
990 MANAGER TERMINAL
N NETWORK

What is claimed is:

1. An analysis apparatus comprising:
at least one memory storing instructions, and
at least one processor configured to execute the instructions to;
supply a learner with content including an examination question;
acquire emotion data regarding learning of the learner for which an emotion analysis has been performed on face image data of the learner who learns using the content;
receive a response of the learner to the examination question; and
control subsequent content based on the acquired emotion data and a result of the response.

2. The analysis apparatus according to claim 1,
wherein the at least one processor configured to execute the instructions to; acquire a time required for a response along with the response of the learner to the examination question, and
change the subsequent content based on the acquired emotion data, a result of the response, and a response time.

3. The analysis apparatus according to claim 1, wherein the at least one processor configured to execute the instructions to;
analyze a motion of the learner from a video of the learner, and
change the subsequent content based on the acquired emotion data, the result of the response, and a motion analysis result.

4. The analysis apparatus according to claim 1,
wherein the at least one processor configured to execute the instructions to; supply content to a plurality of the learners,
acquire the emotion data regarding the learning of each learner, the emotion data being obtained by performing emotion analysis on the face image data of each learner who learns using the content,
wherein the at least one processor configured to execute the instructions to; aggregate the emotion data regarding the plurality of learners based on the emotion data of each learner, comparing the emotion data of the plurality of learners, and identify emotion data of one or more learners, and
change the subsequent content for the one or more identified learners.

5. The analysis apparatus according to claim 4,
wherein the at least one processor configured to execute the instructions to; receive response results of a plurality of the learners to the examination question,
aggregate the emotion data and the response data of each learner, compare the emotion data of the plurality of learners with a plurality of response results, and identify the emotion data of one or more learners, and
control content of the one or more identified learners.

6. The analysis apparatus according to claim 5,
wherein the at least one processor configured to execute the instructions to; calculate a distribution related to a specific emotion and a distribution of a specific response result from the emotion data and the response data of the plurality of learners, and identify one or more learners exceeding a deviation value based on the distributions, and
control the content of the one or more identified learners.

7. The analysis apparatus according to claim 1, wherein the at least one processor configured to execute the instructions to; select content in accordance with a forgetting curve for specific content of a learner.

8. The analysis apparatus according to claim 1, wherein the at least one processor configured to execute the instructions to; select content with different difficulty levels, content with different reproduction rates, or content with different visual pressures.

9. An analysis method comprising:
supplying a learner with content including an examination question;
acquiring emotion data regarding learning of the learner for which an emotion analysis has been performed on face image data of the learner who learns using the content;
receiving a response of the learner to the examination question; and
controlling subsequent content based on the acquired emotion data and a result of the response.

10. A non-transitory computer-readable recording medium that stores an analysis program causing a computer to perform:
supplying a learner with content including an examination question;
acquiring emotion data regarding learning of the learner for which an emotion analysis has been performed on face image data of the learner who learns using the content;
receiving a response of the learner to the examination question; and
controlling subsequent content based on the acquired emotion data and a result of the response.

11. The analysis method according to claim 9, further comprising acquiring a time required for a response along with the response of the learner to the examination question, and
wherein the content control includes changing the subsequent content based on the acquired emotion data, a result of the response, and a response time.

12. The analysis method according to claim 9, further comprising:
analyzing a motion of the learner from a video of the learner, and
wherein the content control includes changing the subsequent content based on the acquired emotion data, the result of the response, and a motion analysis result.

13. The analysis method according to claim 9, further comprising:
supplying content to a plurality of the learners,
acquiring the emotion data regarding the learning of each learner, the emotion data being obtained by performing emotion analysis on the face image data of each learner who learns using the content,
aggregating the emotion data regarding the plurality of learners based on the emotion data of each learner, comparing the emotion data of the plurality of learners, and identifying emotion data of one or more learners, and
changing the subsequent content for the one or more identified learners.

14. The analysis method according to claim 9, further comprising:
receiving response results of a plurality of the learners to the examination question,
aggregating the emotion data and the response data of each learner, comparing the emotion data of the plurality of learners with a plurality of response results, and identifying the emotion data of one or more learners, and
controlling content of the one or more identified learners.

15. The analysis method according to claim 9,
wherein the analysis data generation includes calculating a distribution related to a specific emotion and a distribution of a specific response result from the emotion data and the response data of the plurality of learners, and identifying one or more learners exceeding a deviation value based on the distributions, and
controlling the content of the one or more identified learners.

16. The non-transitory computer-readable recording medium according to claim 10, further comprising acquiring a time required for a response along with the response of the learner to the examination question, and
wherein the content control includes changing the subsequent content based on the acquired emotion data, a result of the response, and a response time.

17. The non-transitory computer-readable recording medium according to claim 10, further comprising:
analyzing a motion of the learner from a video of the learner, and
wherein the content control includes changing the subsequent content based on the acquired emotion data, the result of the response, and a motion analysis result.

18. The non-transitory computer-readable recording medium according to claim 10, further comprising:
supplying content to a plurality of the learners,
acquiring the emotion data regarding the learning of each learner, the emotion data being obtained by performing emotion analysis on the face image data of each learner who learns using the content,
aggregating the emotion data regarding the plurality of learners based on the emotion data of each learner, comparing the emotion data of the plurality of learners, and identifying emotion data of one or more learners, and
changing the subsequent content for the one or more identified learners.

19. The non-transitory computer-readable recording medium according to claim 10, further comprising:
receiving response results of a plurality of the learners to the examination question,
aggregating the emotion data and the response data of each learner, comparing the emotion data of the plurality of learners with a plurality of response results, and identifying the emotion data of one or more learners, and
controlling content of the one or more identified learners.

20. The non-transitory computer-readable recording medium according to claim 10,
wherein the analysis data generation includes calculating a distribution related to a specific emotion and a distribution of a specific response result from the emotion data and the response data of the plurality of learners, and identifying one or more learners exceeding a deviation value based on the distributions, and
controlling the content of the one or more identified learners.
